(19) United States
(12) Patent Application Publication
(10) Pub. No.: US 2026/0119284 A1
(43) Pub. Date: Apr. 30, 2026

(54) EFFICIENTLY SHARING CALLS TO GENERATIVE MODEL(S) BETWEEN MULTIPLE AGENTS

(71) Applicant: GDM Holding LLC, Mountain View, CA (US)

(72) Inventors: Matthew Sharifi, Kilchberg (CH); Florian Nils Hartmann, Zurich (CH)

(21) Appl. No.: 18/927,137

(22) Filed: Oct. 25, 2024

(51) Int. Cl. G06F 9/54

(52) U.S. Cl. CPC G06F 9/542; G06F 2209/544

(57) ABSTRACT

Implementations relate to obtaining, from each agent of a plurality of agents, a respective agent query, wherein each respective agent query includes a respective natural language request for performance of a respective generative task; aggregating each respective agent query to form a joint query; causing the joint query to be processed using a generative model to generate responsive content; and broadcasting, to each agent of the plurality of agents, at least some of the responsive content generated using the generative model, wherein the responsive content is responsive to the joint query.

### BACKGROUND

Various generative model(s) (GM(s)) have been proposed that can be used to process natural language (NL) content and/or other input(s), to generate output that reflects generative content that is responsive to the input(s). For example, large language model(s) (LLM(s)) have been developed that can be used to process NL content and/or other input(s), to generate LLM output that reflects generative NL content and/or other generative content that is responsive to the input(s). Some GM(s) can be foundation models. Foundation models are typically trained on enormous amounts of diverse data. For example, a foundation model configured to generate text can be trained on data from, but not limited to, webpages, software code, electronic news articles, and machine translation data.

In some instances, inputs to GM(s) can be formulated and/or provided by “agent(s)” in order for these agent(s) to perform various tasks. These agent(s) may be hosted at or otherwise accessible to client devices, and may in turn have access to a variety of GMs. For example, an agent at a client device may be configured to receive input from a user of the client device and to process the user input using local GM(s) at the client device. The agent may determine in this or other manners that the user has requested performance of NLP task(s) which require or would benefit from input from other GM(s) (e.g., cloud-based GM(s)) accessible to the agent. In various non-limiting examples, this may be because performance of the NLP task requires further computational processing power, requires access to specific function(s), and/or requires access to specific information. In such instances, the agent may determine an agent query which comprises a natural language request for performance of a generative task, and may provide this agent query as input to the appropriate GM(s) for processing.

### SUMMARY

Implementations described herein relate to efficiently sharing and/or aggregating calls or queries to GM(s) between multiple agents. More particularly, but not exclusively, techniques are described herein for coordinating between agents to ensure that contextually similar agent queries are processed efficiently. In a range of scenarios, multiple agents (e.g. multiple agents each corresponding to a particular client device and/or each corresponding to a particular GM) may have separate, but contextually related, agent queries to be provided to particular GM(s) (e.g., cloud-based GM(s)). Issuing these agent queries to the GM(s) separately may cause the GM(s) to process the queries in a serial manner, e.g., one after another. This can cause processing of the agent queries and generation of responsive content to be slow and computationally intensive. Where the separate agent queries share a similar context (e.g., they relate to a same or similar task, they involve processing same or similar data, etc.), it can be computationally efficient to aggregate the separate agent queries together to form a joint query and to provide the joint query for processing by the GM(s) (for example, in place of the separate agent queries).

In various implementations, each agent of a plurality of agents may have a respective agent query. Each respective agent query may include a respective natural language request for performance of a respective generative task. For example, some or all of the respective agent queries may be received as user inputs at client devices corresponding to the agents. In some instances, GM(s) corresponding to said agents and/or said client devices may process the user input in order to determine the respective agent queries. Additionally or alternatively, some or all of the respective agent queries may be implied agent queries determined by the agents and/or GM(s) corresponding to said agents. In other words, implied agent queries may not be directly based on any specific user input. The respective agent queries may be obtained or received by one or more of the agents. For example, the respective agent queries may be obtained by a ‘query issuing agent’ of the plurality of agents.

The respective agent queries and/or the respective generative tasks may share one or more same or similar (e.g., above a threshold similarity) contextual factors. For example, the respective agent queries may have been received or otherwise generated (for example, at client devices each corresponding to a particular agent of the plurality of agents) at a similar time and/or from a similar location. More specifically, respective agent queries may be deemed to share a degree of similarity above a threshold similarity if they are received/generated within a particular time window (e.g., within a 1 minute, a 10 minute, or a 1 hour window, etc.) and/or if they are received/generated within a radius of a particular location (e.g., within a 10 meter, a 100 meter, or a 1 kilometer radius, etc.). In additional or alternative examples, the respective generative tasks may share a similar type of task, and/or may involve processing similar data. In additional or alternative examples, the respective agent queries may be represented as embeddings, and the embeddings may be similar (e.g., determined using techniques such as cosine similarity, dot product, Euclidean distance, etc.). More specifically, respective agent queries and/or respective generative tasks could be processed using one or more classifiers, and the respective agent queries and/or respective generative tasks may be deemed to share a degree of similarity above a threshold similarity based on results provided by these classifier(s). For instance, a classifier could be used to sort respective generative tasks into task types, and the respective generative tasks could be deemed to share a degree of similarity above a threshold similarity if they are classified as the same task type. As another example, a classifier could be used to sort respective agent queries based on a type of their embedding representation, and the respective agent queries could be deemed to share a degree of similarity above a threshold similarity if they are classified as having the same embedding representation type.

Each of the respective agent queries may be aggregated to form a joint query. Aggregating the respective agent queries may involve compiling, summarizing, and/or otherwise combining each of the respective agent queries into a joint query which represents each of the individual agent queries. In one particular example, aggregating two identical agent queries could involve ‘deduplicating’ the agent queries to provide a single joint query. The aggregation may be performed, for example, by one of the agents (e.g., the query issuing agent) and/or by one or more GM(s) (e.g., a local GM accessible at a client device corresponding to the query issuing agent). As described herein, local GM(s) may have billions of parameters, but may have fewer parameters than other GM(s), such as cloud-based GM(s) described herein. For example, a local GM may have fewer than 1 billion, fewer than 2 billion, fewer than 4 billion, fewer than 8 billion, fewer than 10 billion, or fewer than 27 billion parameters.

The joint query may be distributed to each agent of the plurality of agents. This may allow each of the agents (or in some cases, a human operating the computing device associated with the agent) an opportunity to review the joint query and ensure that it is representative of their respective agent query. For example, an agent may process the joint query using one or more GM(s) (e.g., a local GM accessible to the agent and/or accessible to a client device corresponding to the agent) to determine whether the joint query is sufficiently representative of their respective agent query. The distribution of the joint query may be performed, for example, by one of the agents (e.g., the query issuing agent).

In various examples, an ‘interim’ query may initially be distributed to each agent of the plurality of agents. By processing the interim query (e.g., as described above with respect to the joint query), each agent may either determine that the interim query is sufficiently representative of their respective agent query or may determine feedback indicative of how the interim query could be improved to better represent their respective agent query. Feedback from the agents can be taken into account (e.g., by the agent and/or one or more GM(s) which performs the aggregation) and the interim query can be replaced with a final query which better represents each of the respective agent queries. This feedback process can be repeated any number of times. For example, the feedback process can be repeated until each agent of the plurality of agents agrees that the joint query is sufficiently representative of their respective agent query.

The joint query may be provided to a GM to be processed using the GM. This GM is referred to herein as the cloud-based GM, although this is non-limiting, and in some implementations the cloud-based GM may be implemented e.g., at a client device. The joint query may be provided, for example, by one of the agents (e.g., the query issuing agent). The cloud-based GM selected for processing the joint query may be selected based on the type of generative task(s) which the joint query relates to. As one example, the joint query may request performance of one or more generative task(s) based on one or more portions of text data. In this example, the cloud-based GM selected may be a large language model (LLM), and the one or more portions of text data may be provided to the LLM for processing along with the joint query. As an additional or alternative example, the joint query may request performance of one or more generative task(s) based on one or more portions of video data, one or more portions of audio data, and/or one or more images. In this example, the cloud-based GM selected may be a multi-modal GM, and the one or more portions of video data, the one or more portions of audio data, and/or the one or more images may be provided to the multi-modal GM for processing along with the joint query.

At least some of the responsive content, which has been generated using the cloud-based GM and is responsive to the joint query, may be broadcast to each agent of the plurality of agents. The responsive content may initially be received, for example, by one of the agents (e.g., the query issuing agent) and then broadcast to each agent of the plurality of agents. It will be appreciated that in other examples, the responsive content may be broadcast to each agent of the plurality of agents directly from a server that implements the cloud-based GM. Each agent of the plurality of agents can process the responsive content (e.g., using a local GM accessible to the agent and/or accessible to a client device corresponding to the agent) to determine at least a portion of the responsive content which is responsive to the respective agent query for the agent. This portion of the responsive content may then be rendered (e.g., at a display or speaker of a client device corresponding to the agent), optionally alongside the joint query.

In some examples, the responsive content may comprise a digital signature. This digital signature may be computed by signing the responsive content (and optionally the joint query and/or any data or parameters for processing the joint query) using a private key corresponding to the cloud-based GM which processes the joint query and which is used for generating the responsive content. In such examples, upon receiving the responsive content, each agent of the plurality of agents can verify, using a public key corresponding to the cloud-based GM, that this particular cloud-based GM was indeed used for generating the responsive content (and optionally that the responsive content was generated following processing of the agreed joint query).

Sharing calls or queries to cloud-based GM(s) between multiple agents in this manner may provide a variety of technical advantages. Some GM(s) (e.g., the LLM(s), multi-modal GM(s), and/or other cloud-based GM(s) as described above) may be capable of generating steps to complete enormous variations of tasks, as well as an enormous variety of other types of output (e.g., the responsive content described above). However, to achieve this level of robustness, these GM(s) may have hundreds of billions of parameters. As described herein, cloud-based GM(s) may have billions of parameters, and may have more parameters than other GM(s), such as local GM(s) described herein. For example, a cloud-based GM may have more than 70 billion, more than 100 billion, more than 200 billion, more than 400 billion, or more than 1 trillion parameters. Consequently, processing agent queries using these GM(s) may be computationally expensive and/or may introduce significant latency. By using the techniques described herein to consolidate multiple semantically similar GM queries into a shared GM query, it may be possible to reduce the number of calls or queries to cloud-based GM(s), both reducing the computational resource usage at the cloud-based GM(s), as well as collectively reducing latency time for the agents to receive responsive content responsive to their respective agent queries (e.g., by ensuring that computational resource usage at the cloud-based GM is not duplicated unnecessarily across processing multiple agent queries). In turn, reducing computational resource usage at the cloud-based GM(s) can potentially allow individual calls or queries to be processed for a longer period by the cloud-based GM(s) without increasing overall computational resource expenditure. It will be appreciated that this approach can leverage inference-time effects associated with GM(s) to provide better (e.g., more accurate) responses to calls or queries.

Additionally or alternatively, consolidating multiple semantically and/or contextually similar GM agent queries into a shared GM query may provide a variety of other technical benefits. As one example, agent queries may involve processing large amounts of input data (e.g., large text, audio, image, and/or video data files which may be referenced by an input prompt), which may be common to (e.g., overlapping between) the multiple individual agent queries. It can be computationally expensive to unnecessarily repeat processing of this input data by the cloud-based GM, as well as waste of network resources to unnecessarily repeat transmission of this data to an entity which implements the cloud-based GM (e.g., a remote server), and a waste of memory resources to unnecessarily store multiple instances of this data at said entity. As another example, the cloud-based GM may generate large amounts of responsive content (e.g., large text, audio, image, and/or video data files), which may be responsive to multiple individual agent queries. Again, it can be a waste of computational and/or network resources to unnecessarily repeat storage, processing, and/or broadcasting of this responsive content. As another example, processing performed using the cloud-based GM may involve calls to, or processing by, external system(s) or tool(s), such as a communication system (e.g., a phone system) and/or a booking system (e.g., a reservation system), which may again be common to multiple individual agent queries. By avoiding repetition of calls to, or processing by, these external system(s) or tool(s), these techniques can again allow computational and/or network resource usage to be minimized.

In some instances, it may be possible for cloud-based GM(s) to use caching techniques to reuse previously determined responsive content for responding to agent queries. However, the techniques described herein extend the ability of cloud-based GM(s) to reduce computational resource usage in scenarios where caching techniques are not technically feasible or possible. For example, caching techniques may be reliant on identifying identical agent queries in order to reuse responsive content. The techniques described herein are not reliant on agent queries being identical, but allow efficient grouping of a wide variety of contextually/semantically similar agent queries (which the cloud-based GM would not otherwise be able to reliably identify as candidates for sharing computational resource usage). As another example, caching techniques may be reliant on maintaining a memory-intensive and accessible cache of responsive content. The techniques described herein forgo the need for storage of and access to such a cache.

### BRIEF DESCRIPTION OF THE DRAWINGS

FIG. 1 depicts a block diagram of an example environment that demonstrates various aspects of the present disclosure, and in which some of the implementations disclosed herein can be implemented.

FIG. 2 depicts a process flow for utilizing various components from the example environment of FIG. 1, in accordance with various implementations.

FIG. 3 depicts a flowchart that illustrates an example method for efficiently sharing and/or aggregating calls or queries to GM(s) between multiple agents.

FIG. 4 depicts a flowchart that illustrates an example method, optionally implemented by an agent of a plurality agents, for efficiently sharing and/or aggregating calls or queries to GM(s) between multiple agents.

FIGS. 5A and 5B depict various non-limiting examples of efficiently sharing and/or aggregating calls or queries to GM(s) between multiple agents, in accordance with various implementations.

FIG. 6 depicts an example architecture of a computing device, in accordance with various implementations.

### DETAILED DESCRIPTION

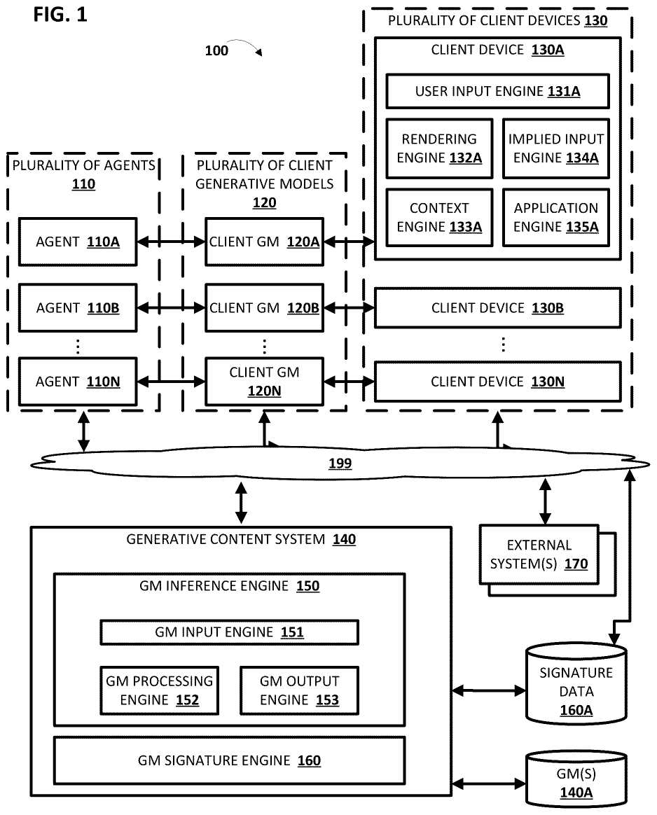

Turning now to FIG. 1, a block diagram of an example environment 100 that demonstrates various aspects of the present disclosure, and in which implementations disclosed herein can be implemented is depicted. The example environment 100 includes a plurality of agents 110, a plurality of client generative models (GMs) 120, a plurality of client devices 130, a generative content system 140, and external system(s) 170. Although illustrated separately, in some implementations all or aspects of the plurality of agents 110, plurality of client GMs 120, and/or plurality of client devices 130 can be implemented as part of one or more cohesive systems (e.g., where agent 110A and/or client GM 120A are hosted at client device 130A, agent 110B and/or client GM 120B are hosted at client device 130B, etc.). Although illustrated separately, in some implementations all or aspects of the generative content system 140 and the plurality of client devices 130 can be implemented as part of one or more cohesive systems (e.g., where generative content system 140 is hosted at one or more of client devices 110A, 110B, etc.). Although illustrated separately, in some implementations all or aspects of the generative content system 140 and the external system(s) 170 can be implemented as part of a cohesive system.

In some implementations, all or aspects of the generative content system 140 can be implemented locally at one or more of the client devices 130. In additional or alternative implementations, all or aspects of the generative content system 140 can be implemented remotely from the plurality of client devices 130 as depicted in FIG. 1 (e.g., at remote server(s)). In those implementations, one or more of the client devices 130 and the generative content system 140 can be communicatively coupled with each other via one or more networks 199, such as one or more wired or wireless local area networks (“LANs”, including Wi-Fi LANs, mesh networks, Bluetooth, near-field communication, etc.) or wide area networks (“WANs”, including the Internet). Similarly, one or more of the client devices 130 and the external system(s) 170 can be communicatively coupled with each other via the one or more networks 199.

Each client device of the plurality of client devices 130 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The following description of an example client device is made with respect to client device 130A (including one or more of: a user input engine 131A, a rendering engine 132A, a context engine 133A, an implied input engine 134A, and an application engine 135A). However, it will be appreciated that client devices 130B, 130C, . . . , 130N, etc., or any other client device of the plurality of client devices may comprise corresponding features (e.g., client device 130N may include one or more of: a user input engine 131N, a rendering engine 132N, a context engine 133N, an implied input engine 134N, and an application engine 135N), and/or may provide corresponding features to those of client device 130A.

The client device 130A can execute one or more software applications, via application engine 135A, through which NL inputs, touch inputs, and/or other user inputs (e.g., including respective ‘agent queries’ referred to herein, such as agent query 201A) can be provided and/or selected, and/or content that is responsive to the NL inputs, touch inputs, and/or other user inputs (e.g., including ‘responsive content’ referred to herein such as responsive content 205 or a portion of the responsive content 206A) can be rendered (e.g., visually and/or audibly). The application engine 135A can execute one or more software applications that are separate from an operating system of the client device 130A (e.g., installed “on top” of the operating system)—or can alternatively be implemented directly by the operating system of the client device 130A. For example, the application engine 135A can execute a web browser, generative application (e.g., generative assistant application), or automated assistant installed on top of the operating system of the client device 130A. As another example, the application engine 135A can execute a web browser software application, a generative software application (e.g., a generative assistant software application), or automated assistant software application that is integrated as part of the operating system of the client device 130A. The application engine 135A (and the one or more software applications executed by the application engine 135A) can interact with or otherwise provide access to (e.g., act as a front-end for) the generative content system 140.

In various implementations, the client device 130A can include a user input engine 131A that is configured to detect user input provided by a user of the client device 130A using one or more user interface input devices (e.g., including respective agent queries referred to herein, such as agent query 201A). For example, the client device 130A can be equipped with one or more microphones that capture audio data, such as audio data corresponding to spoken utterances of the user or other sounds in an environment of the client device 130A. Additionally, or alternatively, the client device 130A can be equipped with one or more vision components that are configured to capture vision data corresponding to images and/or movements (e.g., gestures) detected in a field of view of one or more of the vision components. Additionally, or alternatively, the client device 130A can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 130A.

Some instances of input (e.g., agent queries described herein) can be a query for a response that is formulated based on user input provided by a user of the client device 130A and detected via user input engine 131A. For example, the query can be a typed query that is typed via a physical or virtual keyboard, a suggested query that is selected via a touch screen or a mouse of the client device 130A, a spoken voice query that is detected via microphone(s) of the client device 130A (and optionally directed to an automated assistant executing at least in part at the client device 130A), or an image or video query that is based on vision data captured by vision component(s) of the client device 130A (or based on NL input generated based on processing the image using, for example, object detection model(s), captioning model(s), etc.). Other instances of NL input described herein can be a prompt for content that is formulated based on user input provided by a user of the client device 130A and detected via the user input engine 131A. For example, the prompt can be a typed prompt that is typed via a physical or virtual keyboard, a suggested prompt that is selected via a touch screen or a mouse of the client device 130A, a spoken prompt that is detected via microphone(s) of the client device 130A, or an image or video prompt that is based on an image or video captured by a vision component of the client device 130A.

In various implementations, the client device 130A can utilize one or more machine learning (ML) model(s) to process the user input. For example, the user input received at the client device 130A can be a spoken utterance. In these examples, the user input engine 131A can process, using automatic speech recognition (ASR) model(s) (e.g., a recurrent neural network (RNN) model, a transformer model, and/or any other type of ML model capable of performing ASR), audio data that capture the spoken utterance and that is generated by microphone(s) of the client device 130A to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 131A can select one or more of the speech hypotheses as recognized text that corresponds to the spoken utterance (e.g., based on the corresponding predicted values for each of the speech hypotheses), such as when the user input engine 131A utilizes an end-to-end ASR model. In other implementations, the user input engine 131A can select one or more of the predicted phonemes (e.g., based on the corresponding predicted values for each of the predicted phonemes), and determine recognized text that corresponds to the spoken utterance based on the one or more predicted phonemes that are selected, such as when the user input engine 131A utilizes an ASR model that is not end-to-end. In these implementations, the user input engine 131A can optionally employ additional mechanisms (e.g., a directed acyclic graph) to determine the recognized text that corresponds to the spoken utterance based on the one or more predicted phonemes that are selected.

Notably, although the ML model(s) are described above as being implemented locally by the client device 130A, it should be understood that is for the sake of example and is not meant to be limiting. For instance, the audio data that captures the spoken utterance can additionally, or alternatively, be streamed to the generative content system 140 and/or external system(s) 170, and the generative content system 140 and/or external system(s) 170 can utilize the ASR model(s) described above (or separate cloud-based ASR model(s)) to generate the ASR output.

In various implementations, the client device 130A can include a rendering engine 132A that is configured to render content for visual and/or audible presentation to a user of the client device 130A using one or more user interface output devices (e.g., including responsive content referred to herein such as responsive content 205 or a portion of the responsive content 206A). For example, the client device 130A can be equipped with a display or projector that enables the content to be rendered as visual content (e.g., image(s), video(s), etc.), and optionally along with other visual content (e.g., textual content), via the client device 130A. Additionally, or alternatively, the client device 130A can be equipped with speaker(s) that enable the content to be rendered as audible content via the client device 130A.

In various implementations, the client device 130A can include a context engine 133A that is configured to determine a client device context (e.g., current or recent context) of the client device 130A and/or a user context of a user of the client device 130A (or an active user of the client device 130A when the client device 130A is associated with multiple users). In some of those implementations, the context engine 133A can determine a context based on data stored in a client device database. The data stored in the client device database can include, for example, client device data that characterizes current or recent interaction(s) of the client device 130A and/or a user of the client device 130A, location data that characterizes a current or recent location(s) of the client device 130A and/or a geographical region associated with a user of the client device 130A, user attribute data that characterizes one or more attributes of a user of the client device 130A, user preference data that characterizes one or more preferences of a user of the client device 130A, user profile data that characterizes a profile of a user of the client device 130A, and/or any other data accessible to the context engine 133A via the client device 130A or otherwise.

For example, the context engine 133A can determine a current context based on a current state of a dialog session (e.g., considering one or more recent inputs provided by a user during the dialog session), profile data, and/or a current location of the client device 130A. For instance, the context engine 133A can determine a current context of “visitor looking for upcoming events in Louisville, Kentucky” based on a recently issued query, profile data, and/or an anticipated future location of the client device 130A (e.g., based on recently booked hotel accommodations). As another example, the context engine 133A can determine a current context based on which software application is active in the foreground of the client device 130A, a current or recent state of the active software application, and/or content currently or recently rendered by the active software application. A context determined by the context engine 133A can be utilized, for example, in supplementing or rewriting NL inputs that are received at the client device 130A, in generating an implied NL input (e.g., an implied query or prompt formulated independent of any explicit NL input provided by a user of the client device 130A), and/or in determining to submit an implied NL input and/or to render result(s) (e.g., responsive content) for an implied NL input.

In various implementations, the client device 130A can include an implied input engine 134A that is configured to: generate an implied NL input (e.g., including respective agent queries referred to herein, such as agent query 201A) independent of any user explicit NL input provided by a user of the client device 130A; submit an implied NL input, optionally independent of any user explicit NL input that requests submission of the NL input; and/or cause rendering of a response for the NL input, optionally independent of any explicit NL input that requests rendering of the response. For example, the implied input engine 134A can use one or more past or current contexts, from the context engine 133A, in generating an implied NL input, determining to submit the implied NL input, and/or in determining to cause rendering of a response that is responsive to the implied NL input. For instance, the implied input engine 134A can automatically generate and automatically submit an implied query or implied prompt based on the one or more past or current contexts. Further, the implied input engine 134A can automatically push the response that is generated responsive to the implied query or implied prompt to cause them to be automatically rendered or can automatically push a notification of the response, such as a selectable notification that, when selected, causes rendering of the response. Additionally, or alternatively, the implied input engine 134A can submit respective implied NL input at regular or non-regular intervals, and cause respective responses to be automatically provided (or a notification thereof to be automatically provided).

As a specific example, assume that a user of client device 130A has just finished a regular meeting which occurs weekly. Shortly following one or more previous meetings of this regular meeting series, the user provided an explicit NL input of “Generate a summary of the meeting including my action items”. This context (which can be identified e.g., by context engine 133A based on e.g., calendar item(s) accessible at client device 130A and the explicit NL input) can be used by the implied input engine 134A to automatically generate an implied NL input of “Generate a summary of the meeting including my action items” for this recently finished meeting (e.g., before the user provides any explicit NL input requesting a summary of the meeting). This implied NL input can be presented to the user for approval and/or can be automatically submitted for completion of the generative task in accordance with the techniques generally described herein. In this manner, computational resources associated with receiving and processing explicit NL input from the user can be saved. It will be appreciated that this is one specific example of implied input generated using implied input engine 134A, and other types of implied input are possible (e.g., implied inputs which can automatically provide a meeting summary including personalized action items to other users present in said meeting).

Further, the client device 130A and/or the generative content system 140 can include one or more memories for storage of data and/or software applications, one or more processors for accessing data and executing the software applications, and/or other components that facilitate communication over one or more of the networks 199. In some implementations, one or more of the software applications can be installed locally at the client device 130A, whereas in other implementations one or more of the software applications can be hosted remotely (e.g., by one or more servers) and can be accessible by the client device 130A over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) (e.g., client devices 130B, 130C, . . . 130N, which can each be associated with different users) can also implement the techniques described herein. For instance, the client device 130A, the one or more additional client devices, and/or any other computing devices of a user can form an ecosystem of devices that can employ techniques described herein. These additional client devices and/or computing devices can be in communication with the client device 130A (directly or indirectly, e.g., over the network(s) 199). As another example, a given client device can be utilized by multiple users in a shared setting (e.g., a group of users, a household, a workplace, a hotel, etc.).

Each agent of the plurality of agents 110 can be used for performing tasks, e.g., tasks (interchangeably described herein as agent queries) requested by a user. For example, each agent of the plurality of agents can correspond to a particular user (of a plurality of users). Each agent of the plurality of agents 110 can perform tasks using, for example, processing resources at a client device (e.g., one or more of the plurality of client devices 130). Additionally or alternatively, each agent of the plurality of agents 110 can perform tasks by, for example, using one or more GMs (e.g., one or more of the plurality of client GMs 120 and/or GM(s) 140). In one particular example, each agent of the plurality of agents 110 can have access to a respective client GM of the plurality of client GMs 120, where the respective agent and respective client GM are hosted at, or otherwise accessible to, a respective client device of the plurality of client devices 130. For this reason, the plurality of client GMs are interchangeably described herein as local GMs, but this is not meant to be limiting. In these scenarios, a first user (or first group of users) can use client device 130A to operate agent 110A which can complete tasks using client GM 120A; a second user (or second group of users) can use client device 130B to operate to operate agent 110B which can complete tasks using client GM 120B, etc.

Although FIG. 1 illustrates each agent of the plurality of agents 110 as corresponding to a respective client GM of the plurality of client GMs 120, and as corresponding to a respective client device of the plurality of client devices 130 (i.e., a 1:1:1 relationship), it should be understood that this is not meant to be limiting. For example, in some instances, the plurality of agents 110 could all be hosted at or otherwise accessible to a particular client device. In these instances, each of the plurality of agents 110 could have access to a respective client GM of the plurality of client GMs 120, or the plurality of agents 110 may have access to a particular client GM. As another example, the plurality of client GMs 120 could all be hosted at or otherwise accessible to a particular client device. It will be appreciated that the techniques described herein are applicable to agent queries from a plurality of agents across a broad range of scenarios (e.g., including scenarios where the plurality of agents 110 do not utilize a plurality of client GMs 120, scenarios where the plurality of agents 110 do not correspond to a plurality of client devices 130, etc.).

The generative content system 140 is illustrated in FIG. 1 as including a generative model (GM) inference engine 150, and a GM signature engine 160. Some of these engines can be combined and/or omitted in various implementations. Further, these engines can include various sub-engines. For instance, the GM inference engine 150 is illustrated in FIG. 1 as including a GM input engine 151, a GM processing engine 152, and a GM output engine 153. Similarly, some of these sub-engines can be combined and/or omitted in various implementations. Accordingly, it should be understood that the various engines and sub-engines of the generative content system 140 illustrated in FIG. 1 are not meant to be limiting. The generative content system 140 can be used to implement one or more of the GMs described herein; in particular the GM(s) (e.g., stored in GM(s) database 140A) used for generating responsive content. These GM(s) used for generating responsive content are interchangeably described herein as cloud-based GMs, but this is not meant to be limiting. Further generative content system(s) and/or inference engine(s) (not illustrated in FIG. 1) may be used to implement some or all of the plurality of client GMs described herein.

Further, the generative content system 140 is illustrated in FIG. 1 as interfacing with various databases, such as GM(s) database 140A, signature data database 160A. GM inference engine 150 may have access to at least GM(s) database 140A and GM signature engine 160 may have access to at least signature database 160A. However, it should be understood that this is for the sake of example and is not meant to be limiting. For instance, in some implementations, each of the various engines and/or sub-engines of the generative content system 140 can have access to each of the various databases. Further, some of these databases can be combined and/or omitted in various implementations. Accordingly, it should be understood that the various databases interfacing with the generative content system 140 illustrated in FIG. 1 are not meant to be limiting.

Moreover, the generative content system 140 can interface with other system(s), such as external system(s) 170. The external system(s) 170 can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.) and/or other tools or functions. In some implementations, the external system(s) 170 are first-party system(s), whereas in other implementations, the external system(s) 170 are third-party system(s). As used herein, the term “first-party” or “first-party entity” refers to an entity that controls, develops, and/or maintains the generative content system 140, whereas the term “third-party” or “third-party entity” refers to an entity that is distinct from the entity that controls, develops, and/or maintains the generative content system 140. Whilst the techniques described herein are generally described with respect to calls or queries to a generative content system, it will be appreciated that these techniques are equally applicable to efficiently sharing calls or queries between agents for other tools or systems (e.g., non-generative tools or systems), which may be provided by external system(s) 170. For example, external system(s) 170 could include communication systems (e.g., phone systems) and/or booking systems (e.g., reservation systems) and the calls or queries could include various kinds of interactions with (e.g., API calls to) these systems.

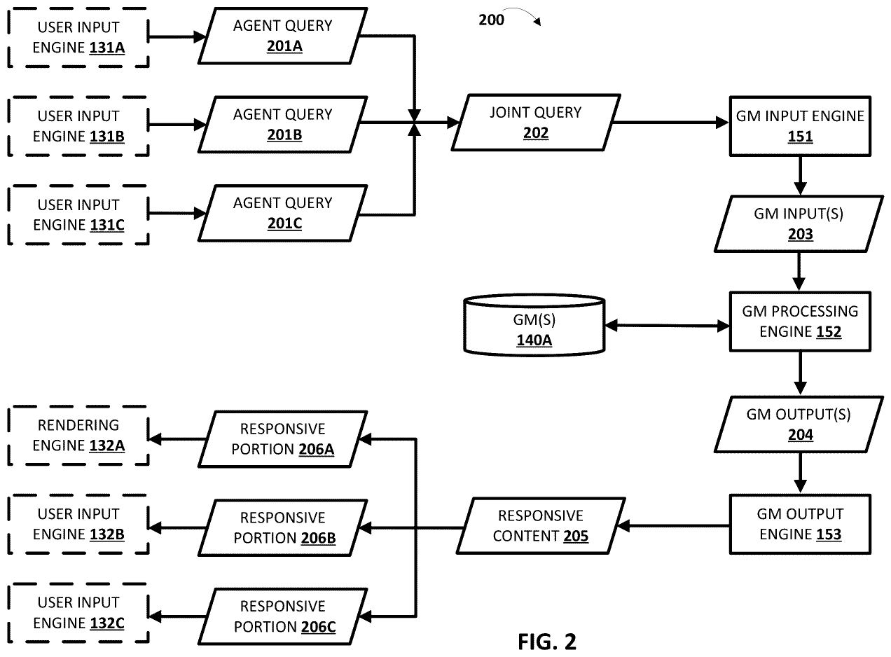

As described in more detail herein (e.g., with respect to FIGS. 2, 3, 4, 5A, and 5B), the generative content system 140 can be utilized to generate responsive content which is responsive to a joint query (e.g., joint query 202). Specifically, the generative content system 140 can access a GM which can process GM input including the joint query to generate corresponding GM output. The generative content system 140 can use the GM inference engine 150 to perform this processing. Based on this GM output, responsive content which is responsive to the joint query can be determined.

The GM input engine 151 can, in response to receiving query/input data (e.g., including joint query 202), generate model input that is to be processed using GM(s) in generating a response to the query/input data. As described herein, such query/input data (e.g., including the joint query 202) can include any combination of input prompt(s), one or more images, one or more portions of video data, one or more portions of audio data, and/or one or more portions of text data. For example, joint query 202 may include a reference to one or more images, one or more portions of video data, one or more portions of audio data, and/or one or more portions of text data, and the query/input data may include both the joint query 202 and the referenced one or more images, one or more portions of video data, one or more portions of audio data, and/or one or more portions of text data. The input data can optionally include additional content, such as contextual information. The GM input engine 151 can, for example, reformat input data into a suitable form for processing using GM(s), e.g., reformat an input NL query as a prompt suitable for an LLM, reformat one or more input images into a tensor for input into an image generation model, etc.

The GM processing engine 152 can process input data that is generated by the GM input engine 151 using appropriate GM(s) to generate response/output data. Such response/output data (e.g., the “GM output” referred to herein) can include a distribution over e.g., a set of potential responsive content, etc., based on processing the query/input data using one or more GM(s).

The GM output engine 153 can determine, based on the response/output data, responsive content generated using the GM(s) for further use in the methods described herein. Such content (e.g., the “responsive content 205” referred to herein, which may be determined from the “GM output”) can be determined by sampling the distributions described above.

The GM signature engine 160 can be used to generate digital signatures. For example, the GM signature engine 160 can be used to sign responsive content (e.g., generated by the GM inference engine 150) by appending or otherwise adding a digital signature to the responsive content. For instance, the GM signature engine 160 can determine a digital signature by signing query/input data (e.g., the query/input data which is processed by GM input engine 151) and responsive content (e.g., the responsive content which is determined by GM output engine 153) with a private key (e.g., a private key which corresponds to the particular GM which was utilized by GM processing engine 152 for generating the responsive content). This private key can be stored (e.g., in GM(s) database 140A) by an entity that maintains/operates the particular GM. A public key for the particular GM can be stored, for example, in signature database 160A. This public key can be used, e.g., by one or more agents of the plurality of agents, to ensure that the responsive content or portion of the responsive content which they receive was generated by the particular GM, for example. More specifically, by ensuring that the private key is stored exclusively by the entity that maintains/operates the particular GM (and is e.g., privately stored at a server or device which implements the particular GM), it can be guaranteed that the generated digital signature must have originated from the particular GM. In this manner, it may be possible to ensure that digital signatures cannot be ‘faked’ or fraudulently generated by entities other than that which maintains/operates the particular GM.

Turning now to FIG. 2, a process flow for utilizing various components from the example environment of FIG. 1 is depicted. For the sake of example, assume that users of each of three client devices 130A, 130B, and 130C each provide natural language user inputs which are detected via user input engines 131A, 131B, and 131C respectively and used to produce agent queries 201A, 201B, and 201C respectively. Although the process flow 200 of FIG. 2 is described with respect to these three agent queries 201A-C being explicit agent queries, it should be understood that this is for the sake of example and is not meant to be limiting. For instance, the agent queries 201A-C can include one or more implied agent queries (e.g., as described with respect to the implied input engine(s) 134N), and the techniques described herein can be applied to more or fewer agent queries.

As a specific example, assume that each of agent queries 201A-C relate to a video generation task. For example, agent query 201A (for agent 110A) could be “Generate a short video which explains section 1 of this article to me”, agent query 201B (for agent 110B) could be “Generate a video which explains sections 1-3 of this article to me”, and agent query 201C (for agent 110C) could be “Generate a long video which explains this article to me”. In some examples, the agents 110A-C can communicate between themselves to recognize that their respective agent queries share one or more same or similar contextual factors (and e.g., that applying the techniques described herein may be appropriate). In additional or alternative examples, one or more other systems (e.g., generative content system 140, external system(s) 170, optionally implemented at remote server(s)) can be used to ‘group’ these agent queries together based on them sharing one or more same or similar contextual factors. In this specific example, the agent queries may have been generated in the same time window (e.g., the same day, following a lecture attended by the users who submitted the natural language user inputs) and/or from a similar location (e.g., on the same university campus).

The user input engines 131A-C can each respectively process the natural language user inputs which they receive to generate agent queries 201A-C. In some examples, the agent queries 201A-C may be obtained independent of the user input engines 131A-C(e.g., they may be implied agent queries). Each of agent queries 201A-C can be obtained by a system (e.g., a query issuing agent of the plurality of agents) which can be configured to aggregate or combine the respective agent queries into a joint query 202. Aggregation of the respective agent queries could involve summarizing the respective agent queries in a manner which avoids excluding aspects of the respective agent queries and which avoids duplicating aspects of the respective agent queries. This aggregation may be performed by using a GM (e.g., by using the client GM accessible to the query issuing agent). As described herein, this aggregation process can also involve iteratively improving an interim query or the joint query by taking into account feedback from the agents. Returning to the specific example, a joint query 202 which aggregates the respective agent queries 201A-C could be “Generate a series of video segments explaining each section of this article”. It will be appreciated that this aggregated agent query avoids duplication, e.g., of explaining section 1, or of explaining sections 1-3 of the article.

The GM input engine 151 can, in response to receiving query/input data (e.g., including joint query 202), generate model input that is to be processed using GM(s) in generating a response to the query/input data. Returning to the specific example, the GM input(s) 203 can include at least the joint query 202 (i.e., “Generate a series of video segments explaining each section of this article”) and the article referenced by the joint query, e.g., in the form of one or more portions of text data.

The GM processing engine 152 can process, using one or more cloud-based GM(s) from the GM(s) database 140A the GM input(s) 203 to generate the GM output(s) 204. In these implementations, the GM output(s) 204 can include a probability distribution over a sequence of tokens, such as words, phrases, or other semantic units that are predicted to be necessary for determining responsive content 205 which is responsive to the joint query 202. The cloud-based GM(s) can include millions or billions of weights and/or parameters that are learned through training the GM(s) on enormous amounts of diverse data. This enables the GM(s) to generate the GM output(s) 204 as the probability distribution over the sequence of tokens. The GM(s) can be initially trained and/or fine-tuned to enable the GM(s) to generate the GM output including the probability distribution over the sequence of tokens. Returning to the specific example, the GM output(s) 204 can include output representative of a series of video segments explaining each section of the article. In this instance, the cloud-based GM used by the GM processing engine 152 may be a multi-modal GM, e.g., a video generation GM which is configured to process text-based inputs and which can be used to generate video-based outputs.

The GM output engine 153 can determine, based on the GM output(s) 204, responsive content 205. For example, the responsive content 205 can be determined by sampling the probability distribution(s) described above. Returning to the specific example, the responsive content 205 can include the video segments explaining each section of the article.

In some instances, each of the client devices 130A-C may receive the responsive content 205. In additional or alternative instances, each of the client devices 130A-C may receive a specific portion of the responsive content 205 which is responsive to their original respective agent query. This portioning of the responsive content may be performed by using a GM (e.g., by using the client GM accessible to the query issuing agent and/or by each agent using its respective client GM). For example, responsive portion 206A which is responsive to agent query 201A may be received at client device 130A, responsive portion 206B which is responsive to agent query 201B may be received at client device 130B, and responsive portion 206C which is responsive to agent query 201C may be received at client device 130C. By providing (to the client devices and/or for rendering) only the portion of responsive content that is responsive to the original agent query of the respective agent, the agent queries of the other agents may remain private. This approach can also reduce network resource usage. Returning to the specific example, the responsive portion 206A could be a short video segment which explains section 1 of the article, the responsive portion 206B could be a longer video which includes segments of video explaining each of sections 1, 2, and 3 of the article, and the responsive portion 206C could be a longer video which includes all of the generated segments of video explaining all of the sections of the article.

The rendering engines 132A-C can each respectively render the responsive content 205 and/or the responsive portions 206A-C at the respective client devices 130A-C. For example, the responsive portion 206A can be rendered for display as video output at client device 130A, the responsive portion 206B can be rendered for display as video output at client device 130B, and the responsive portion 206C can be rendered for display as video output at client device 130C.

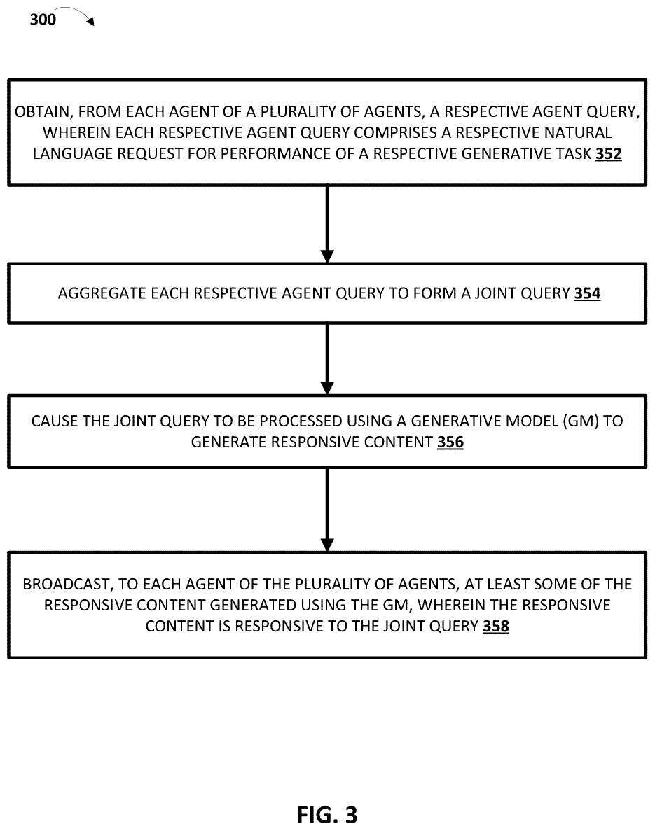

Turning now to FIG. 3, a flowchart is depicted that illustrates an example method 300 for efficiently sharing and/or aggregating calls or queries to generative model(s) (GM(s)) between multiple agents. The method 300 generally corresponds to the method 200 described in relation to FIG. 2. For convenience, the operations of the method 300 are described with reference to a system that performs the operations. This system of the method 300 includes one or more processors, memory, and/or component(s) of computing device(s). Moreover, while operations of the method 300 are shown in a particular order, this is not meant to be limiting. One or more operations may be reordered, omitted, and/or added.

At block 352, the system obtains, from each agent of a plurality of agents, a respective agent query, where each respective agent query includes a respective natural language request for performance of a respective generative task.

For example, the respective agent queries may share one or more same (e.g., identical) or similar (e.g., above a threshold level of similarity) contextual factors, which can optionally cause the system to group each of the agent together as the ‘plurality of agents’. As one example, the respective agent queries may be obtained by the system at a same or similar time (e.g., within a particular timeframe). As another example, the respective agent queries may be obtained by the system from a same or similar location (e.g., the agent queries may be received from a plurality of client devices, where the plurality of client devices are physically located within a particular area and/or are located within a threshold distance from each other). As another example, the respective agent queries may be obtained by the system as embeddings (e.g., vectors) or transformed by the system into embeddings, and these embedding representations may be the same or similar. As another example, the respective agent queries may relate to a same or similar type of respective generative task (e.g., each of the respective generative tasks requires or can be performed by the same particular cloud-based GM). As another example, the respective agent queries may refer to the same or similar input data for the respective generative tasks (e.g., each of the respective generative tasks requires processing of the same/similar text data, image(s), video, and/or audio).

In some instances, all of the respective agent queries may share one or more of these particular contextual factors (e.g., each of the respective agent queries relates to a same or similar type of respective generative task). However, it will be appreciated that in other instances, the respective agent queries may share a mixture of these contextual factors (e.g., a subgroup of the respective agent queries were received at a same or similar time, another (optionally overlapping) subgroup of the respective agent queries were received from a same or similar location, etc.). This approach may allow calls and queries to cloud-based GM(s) to be efficiently grouped together and reduce computational expenditure in scenarios where caching approached are not possible or technically feasible.

A query issuing agent may be selected from among the plurality of agents. This query issuing agent can perform any or all of the method steps shown at block 352, 354, 356, and/or 358 of FIG. 3. In other words, the query issuing agent can effectively act as, or as a component of, the ‘system’ of the method 300. The query issuing agent can be selected based on a consensus of the plurality of agents, which can communicate amongst each other (e.g., via network(s) 199) to select, elect, or otherwise determine a query issuing agent. For example, the query issuing agent can be determined using a leader election algorithm. As another example, the query issuing agent can be determined based on that agent having access to a particular cloud-based GM. As another example, the query issuing agent can be determined based on contact or social network information (e.g., contact or social network information which identifies the chosen query issuing agent as having the highest number of the other plurality of agents as ‘contacts’).

Each agent of the plurality of agents can have access to (e.g., be communicatively coupled with) a respective client (or local) GM of a plurality of client (or local) GMs. For example, each agent can use its respective client GM to help complete tasks. Each agent of the plurality of agents can also correspond to (e.g., be accessible at and/or hosted at) a respective client device of a plurality of client devices. For example, each agent can use processing power of the respective client device to help complete tasks (e.g., by operating the respective client/local GM, which can be hosted at, or run locally at, the respective client device).

At block 354, the system aggregates each respective agent query to form a joint query. For example, where the query issuing agent obtained the respective agent queries, the query issuing agent may also be configured to combine or aggregate these respective agent queries into the joint query. In some instances, the query issuing agent may process input including each of the respective agent queries using its client GM to generate output representative of a joint (or aggregated) query. In other words, the client GM accessible to the query issuing agent can be prompted or otherwise configured to generate output which combines the respective agent queries as an aggregated, joint query.

The system may distribute the joint query to each agent of the plurality of agents. Each agent may then have the opportunity to analyze the joint query (for example, using their respective client GMs) to ensure that the joint query is sufficiently representative of their respective agent query (e.g., that it encompasses all of their respective agent query, that it does not exclude any portions of their respective agent query, etc.). The system can receive feedback from any or all of the plurality of agents regarding the joint query. The feedback can be positive feedback (e.g., indicating that the respective agent approves of the joint query) or negative feedback (e.g., indicating that the respective agent does not approve of the joint query, and optionally providing an explanation of how the joint query could be improved). The system can then update the joint query to provide an ‘updated’ joint query which is responsive to and/or reflective of the feedback received. For example, input including the original joint query and the feedback can be processed using a GM, e.g., the cloud-based GM, to generate output that updates the joint query or is representative of an updated joint query. This process of distributing and updating the joint query can be performed any number of times (e.g., until each agent of the plurality of agents provides positive feedback on the joint query/updated joint query, up to a threshold number of times, etc.).

More specifically, where the query issuing agent is responsible for aggregating the respective agent queries, the query issuing agent may initially determine an ‘interim’ query or ‘interim’ joint query, which can be distributed or broadcast to each agent of the plurality of agents. As described above, any or all of the plurality of agents can provide feedback (e.g., to the query issuing agent) regarding whether the interim query is sufficiently representative of their respective agent query. This feedback may be provided in a natural language form. The query issuing agent can then update the interim query (e.g., such that the interim query becomes the final joint query). For example, the query issuing agent can process input including the interim query and the feedback using a GM, e.g., the respective client GM accessible to the query issuing agent to generate output representative of an ‘updated’ interim query (or a ‘final’ joint query). It will be appreciated that in some examples, first, second, . . . , and n-th interim queries can be generated and iteratively improved through this feedback process before the final joint query is determined (where the joint query is determined e.g., as the query which each of the agents agree is sufficiently representative of their respective agent query, as the query after a threshold number of iterations of the feedback process, etc.).

At block 356, the system causes the joint query to be processed using a generative model (GM) to generate responsive content. The GM may be referred to herein as the cloud-based GM, although this is not limiting, and in some instances, the cloud-based GM can be hosted at one or more of the plurality of client devices. The GM may be a foundation model. Foundation models may be trained on a wide variety (e.g., with respect to breadth and/or volume) of training data, and may thus be adaptable for use in performing a broad range of tasks.

The GM can additionally or alternatively be, or include, a large language model (LLM). For example, where the respective agent queries and/or the joint query relate to respective generative task(s) which involve processing one or more portions of text data (and e.g., include references to these one or more portions of text data), the one or more portions of text data may be used as input data to be processed by the cloud-based GM alongside the joint query. It may be appropriate to process joint queries of this type, and their associated input data, using an LLM.

The GM can additionally or alternatively be, or include, a multi-modal GM (e.g., which can process input(s) in a plurality of modalities and/or be used to generate output(s) in a plurality of modalities). For example, where the respective agent queries and/or the joint query relate to respective generative task(s) which involve processing one or more portions of video data, one or more portions of audio data, and/or one or more images (and e.g., include references to these one or more portions of video data, one or more portions of audio data, and/or one or more images), the one or more portions of video data, one or more portions of audio data, and/or one or more images may be used as input data to be processed by the cloud-based GM alongside the joint query. It may be appropriate to process joint queries of this type, and their associated input data, using a multi-modal GM. It will be appreciated that additionally or alternatively, the respective agent queries may relate to respective generative task(s) which request generation of one or more portions of video data, one or more portions of audio data, and/or one or more images, and so the joint query may also request generation of one or more portions of video data, one or more portions of audio data, and/or one or more images. Again, it may be appropriate to process joint queries of this type using a multi-modal GM.

At block 358, the system broadcasts, to each agent of the plurality of agents, at least some of the responsive content generated using the GM, where the responsive content is responsive to the joint query. In some instances, the complete responsive content may be broadcast to each agent of the plurality of agents. Responsive content may be broadcast to the agents via the query issuing agent, i.e., the responsive content is firstly received at the query issuing agent which then broadcasts the responsive content to each agent of the plurality of agents. In some instances, the query issuing agent may be able to process input including the responsive content using a GM (e.g., using the client GM accessible to the query issuing agent) to generate output representative of relevant portion(s) of the responsive content for each particular agent (e.g., portion(s) of the responsive content which are responsive to the original respective agent query for each agent). The query issuing agent may then then only broadcast these portion(s) of the responsive content to each agent of the plurality of agents. In some instances, the complete responsive content may be broadcast to each agent of the plurality of agents. Each agent may then individually process input including the responsive content using a GM (e.g., using a client GM accessible to the respective agent) to generate output representative of at least a portion of the responsive content which is responsive to their original agent query. These relevant portion(s) of the responsive content can optionally be rendered as output (e.g., visual or audible output) at the respective client device corresponding to each agent. The joint query can optionally be rendered (e.g., visual or audible output) at the respective client device alongside the responsive content.

The responsive content, or the relevant portion(s) of the responsive content may include a digital signature. This digital signature can be computed and added to the responsive content by the cloud-based GM after the responsive content is determined. For example, the digital signature can be computed by using a private key which corresponds to the particular cloud-based GM to sign the generated responsive content, as well as (optionally) the joint query and any associated input data which were used to generate the responsive content. By retrieving a public key corresponding to the particular cloud-based GM, each agent of the plurality of agents can verify that the responsive content was genuinely determined using the particular cloud-based GM. Optionally, this public key can also be used to verify that the responsive content was determined using the agreed upon joint query (along with any associated input data referenced by the joint query).

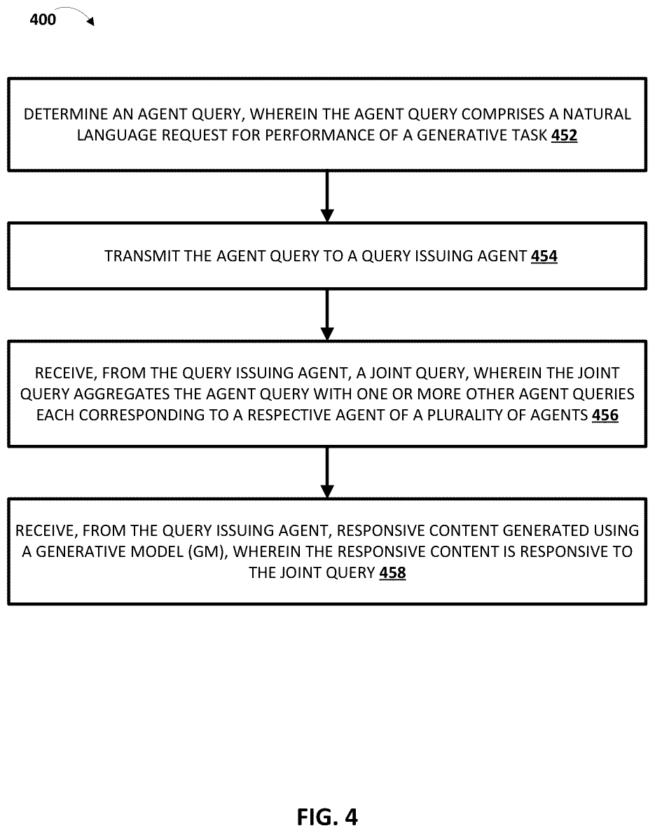

Turning now to FIG. 4, a flowchart is depicted that illustrates an example method 400, optionally implemented by an agent of a plurality agents, for efficiently sharing and/or aggregating calls or queries to GM(s) between multiple agents. The agent may have access to (e.g., be communicatively coupled with) a client GM, and the agent may correspond to (e.g., be accessible at and/or hosted at) a client device. The client GM may also be accessible at and/or hosted at the client device (i.e., as a local GM). For convenience, the operations of the method 400 are described with reference to a system (e.g., an agent 110N of the plurality of agents 110) that performs the operations. This system of the method 400 includes one or more processors, memory, and/or component(s) of computing device(s). Moreover, while operations of the method 400 are shown in a particular order, this is not meant to be limiting. One or more operations may be reordered, omitted, and/or added.

At block 452, the system determines an agent query, where the agent query comprises a natural language request for performance of a generative task.

At block 454, the system transmits the agent query to a query issuing agent. For example, the query issuing agent may be determined based on a consensus of the plurality of agents, which can communicate amongst each other (e.g., via network(s) 199) to select, elect, or otherwise determine a query issuing agent in the manners described herein.

At block 456, the system receives, from the query issuing agent, a joint query, wherein the joint query aggregates the agent query with one or more other agent queries each corresponding to a respective agent of the plurality of agents. In some instances, the system may initially receive an interim query (or interim joint query) from the query issuing agent. The agent can process input including this interim query using its client GM to generate output representative of first feedback which is indicative of a degree of correspondence between the interim query and the agent query (e.g., an indication of whether the interim query is sufficiently representative of the agent query, such as whether the interim query encompasses all of the agent query, whether the interim query fails to represent aspects of the agent query, etc.). This first feedback may be provided in a natural language form. By subsequently providing this first feedback to the query issuing agent, the query issuing agent can use this first feedback to update the joint query and/or replace the interim query with a joint query in the manners described herein. This process of using feedback to update the joint query and/or replace the interim query with a joint query can be repeated any number of times.

Once the agent deems the joint query to be sufficiently representative of its agent query (e.g., the degree of correspondence between the joint query and the agent query is sufficiently high), second feedback (or e.g., a confirmation message based on the second feedback) can be provided to the query issuing agent indicative of approval of the joint query by the agent. This second feedback can be determined by using the agent's client GM in a similar manner to the first feedback. For example, the agent can process input including at least the joint query using its client GM to generate output representative of second feedback which is indicative of a degree of correspondence between the joint query and the agent query.

At block 458, the system receives, from the query issuing agent, responsive content generated using a generative model (GM, e.g., a cloud-based GM), where the responsive content is responsive to the joint query. For example, the respective agent queries and/or joint query may include a reference to one or more portions of text data, and processing the joint query may involve processing the one or more portions of text data alongside the joint query. In these and other scenarios, the cloud-based GM may be, or include, a large language model (LLM). As another example, the respective agent queries and/or joint query may include a reference to one or more portions of video data, one or more portions of audio data, and/or one or more images, and processing the joint query may involve processing the one or more portions of video data, one or more portions of audio data, and/or one or more images alongside the joint query. In these and other scenarios, the cloud-based GM may be, or include, a multi-modal GM. In various scenarios, the GM may be a foundation model. Foundation models may be trained on a wide variety (e.g., with respect to breadth and/or volume) of training data, and may thus be adaptable for use in performing a broad range of tasks.

In some instances, the responsive content received by the system may include all of the responsive content determined by the cloud-based GM responsive to the joint query. As such, it may be desirable to determine a particular portion of the responsive content which is responsive to the agent's original agent query (e.g., for rendering for a user who may have issued the original agent query). For example, the agent can process input including the responsive content (and optionally the original agent query) using its client GM to generate output representative of a portion of the responsive content which is responsive to the agent query. This portion of the responsive content which is responsive to the original agent query (or the responsive content as a whole) can optionally be rendered as output (e.g., visual or audible output) at the respective client device corresponding to the agent. The joint query can optionally be rendered (e.g., visual or audible output) at the respective client device alongside the responsive content.

The responsive content, or the relevant portion(s) of the responsive content may include a digital signature. This digital signature can be computed and added to the responsive content by the cloud-based GM after the responsive content is determined. For example, the digital signature can be computed by using a private key which corresponds to the particular cloud-based GM to sign the generated responsive content, as well as (optionally) the joint query and any associated input data which were used to generate the responsive content. By retrieving a public key corresponding to the particular cloud-based GM, the agent can verify that the responsive content was genuinely determined using the particular cloud-based GM. Optionally, this public key can also be used to verify that the responsive content was determined using the agreed upon joint query (along with any associated input data, e.g., input data referenced by the joint query).

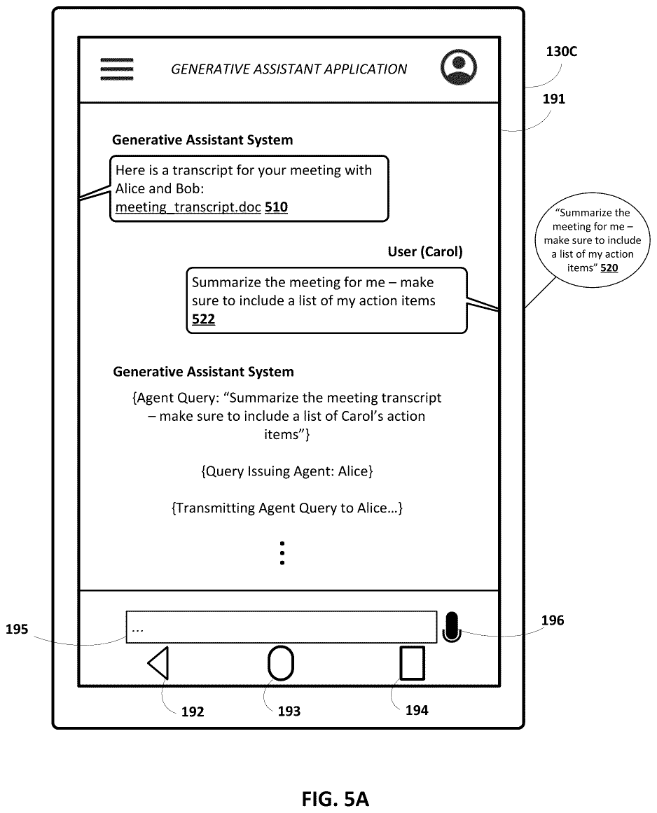

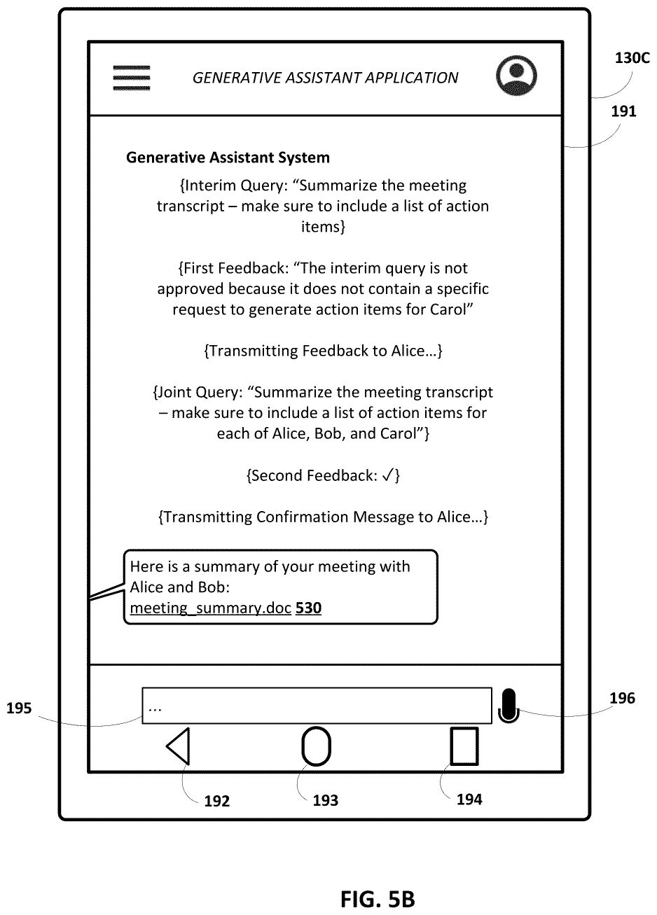

Turning now to FIGS. 5A and 5B, various non-limiting examples of efficiently sharing and/or aggregating calls or queries to GM(s) between multiple agents are depicted. A client device 130C (e.g., the client device 130C described with reference to FIGS. 1 and 2) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 130C can include various system interface elements 192, 193, and 194 (e.g., hardware and/or software interface elements) that may be interacted with by a user of the client device 130C to cause the client device 130C to perform one or more actions. The display 191 of the client device 130C enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196—or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 130C). Although the client device 130C depicted in FIGS. 5A and 5B is a mobile phone, it should be understood that is for the sake of example and is not meant to be limiting. For example, the client device 130C may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 130C.

Referring specifically to FIG. 5A, assume that a user of the client device 110C accesses a generative assistant application, via the client device 110C, that enables the user to interact with a generative content system (e.g., the generative content system 140 of FIG. 1). Further assume that a generative assistant system provides the user with a notification or message 510 of “Here is a transcript for your meeting with Alice and Bob: meeting_transcript.doc” via the generative assistant application, and that the user provides an input 522 of “Summarize the meeting for me—make sure to include a list of my action items” by providing a corresponding spoken utterance 520. Performing the generative task (e.g., generating a summary of the meeting which includes a list of the user's tasks to follow up on) may require use of a cloud-based LLM. Use of a particular cloud-based LLM may be specified by the user, may be implicit, or may be selected e.g., by an agent of the user). Generative tasks of this nature can be computationally expensive and time consuming for the LLM, particularly where “meeting_transcript.doc” is a large file.

In this example, the transcript of the meeting may be provided in a text-based ‘doc’ format. However, in other examples, the meeting may have been recorded e.g., in an audio or video format, and so the ‘transcript’ may be a larger audio-based or video-based file. In these cases, the generative task may be even more computationally expensive and time consuming, taking minutes or even hours to complete.

In response to receiving the input 522, the generative assistant system and/or an agent of the user may reformat the input 522 as an agent query (e.g., to explicitly identify the task to be performed and the input data to be used). FIG. 5A shows that the agent query in this instance may be “Summarize the meeting transcript—make sure to include a list of Carol's action items”. The generative assistant system, agent of the user, and/or another system may identify other contextually similar agent queries, for example based on the fact that Alice and Bob were in the same meeting and provided agent queries relating to the same transcript. As one example, Alice's agent may have an agent query of “Summarize the meeting transcript—make sure to include a list of Alice's action items” and Bob's agent may have an agent query of “Summarize the meeting transcript—make sure to include a list of Bob's action items”.

The three agents corresponding to Alice, Bob, and Carol respectively may determine a query issuing agent from among themselves. For instance, based on Alice being a mutual contact of both Bob and Carol (where e.g., Bob and Carol are not direct contacts), Alice's agent may be elected as query issuing agent. As such, both Bob and Carol may transmit their agent requests to Alice. For example, Carol's agent may transmit their agent query to client device 130A which corresponds to Alice's agent. It will be appreciated that, in various implementations, the agent query, query issuing agent, and transmission information shown in FIG. 5A is not rendered (e.g., visually and/or audibly) for presentation to the user, i.e., this information may not be perceivable by a user.

Through the techniques described herein (e.g., using a client GM corresponding to Alice's agent), the query issuing agent may aggregate the three respective agent queries to form a joint query. In this instance, the three respective agent queries may firstly be aggregated as an interim query which is distributed back to each of the agents (i.e., those corresponding to Bob and Carol). Referring now specifically to FIG. 5B, the interim query in this instance may be “Summarize the meeting transcript—make sure to include a list of action items”.

Through the techniques described herein (e.g., using a client GM corresponding to Carol's agent and hosted on client device 130C), Carol's agent may determine first feedback which indicates that “The interim query is not approved because it does not contain a specific request to generate action items for Carol”. This first feedback can be transmitted to the query issuing agent (in a similar manner to the agent query).

Through the techniques described herein (e.g., using a client GM corresponding to Alice's agent), the query issuing agent can update or replace the interim query to take account of the feedback (and any feedback received from e.g., Bob's agent). In this instance, the new query (sometimes a second interim query, but in this instance the final, joint query) may be “Summarize the meeting transcript—make sure to include a list of action items for each of Alice, Bob, and Carol”.

Through the techniques described herein (e.g., using a client GM corresponding to Carol's agent and hosted on client device 130C), Carol's agent may determine second feedback which indicates that the joint query is sufficiently representative of the original agent query, and is approved. This second feedback can be transmitted to the query issuing agent (in a similar manner to the first feedback and agent query). It will be appreciated that, in various implementations, the query, feedback, and transmission information shown in FIG. 5B is not rendered (e.g., visually and/or audibly) for presentation to the user, i.e., this information may not be perceivable by a user.

Based on the joint query being approved by all of the agents (because it is sufficiently representative of all of the respective agent queries), the query issuing agent can transmit the joint query to an appropriate GM for processing. In this text-based example, an LLM (e.g., corresponding to the generative assistant system) can be used to process input including the joint query.

The generative assistant system may provide the user with a notification or message 530 of “Here is a summary of your meeting with Alice and Bob: meeting_summary.doc” as shown in FIG. 5B. In this instance, the “meeting_summary” document can be responsive content generated by the LLM responsive to processing the joint query. In this instance (based on the meeting transcript already having been shared between the three agents), the meeting summary may include a summary of the meeting alongside separate action items for each of Alice, Bob, and Carol. In other examples, (e.g., where the respective agent requests should be kept private) the meeting summary may only include the summary of the meeting alongside action items for Carol. In these examples, this portion of the responsive content can be determined through the techniques described herein (e.g., using a client GM corresponding to the query issuing agent or using a client GM corresponding to Carol's agent).

The responsive content (i.e., the meeting_summary document) can be rendered for display at client device 130C, optionally alongside the joint query (which may explain to the user why a list of Alice and Bob's action items have additionally been generated). In some instances, the responsive content may be rendered responsive to verifying a digital signature included in the responsive content. To do this, Carol's agent can retrieve a public key corresponding to the LLM which generated the responsive content and use this to verify the digital signature (which would have been computed by the LLM using a corresponding private key). This verification process can allow each agent to independently ensure that the responsive content was genuinely produced using the LLM, and optionally to ensure that the LLM produced the responsive content based on processing input including the agreed-upon joint query (as shown in FIG. 5B) and input data (i.e., the meeting_transcript file).

In the example shown in FIGS. 5A and 5B, the use of the techniques described herein may provide a variety of technical advantages. For example, processing each of the Alice, Bob, and Carol's agent requests separately (e.g., in a serial manner) would be more computationally expensive and time consuming. The techniques described herein improve computational efficiency of the LLM by minimizing or entirely preventing processing which is common to the three generative tasks from being repeated (e.g., summarizing the meeting, identifying action items which are shared across multiple users, etc.). This sharing, or amortizing, of calls or queries to the cloud-based LLM between multiple agents can reduce overall computation resource usage at the LLM, as well as reducing the total time required to provide responsive content to the agents.

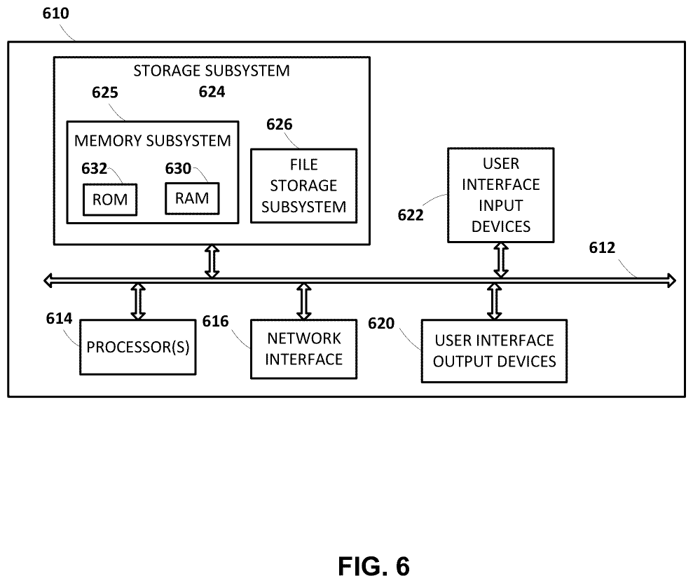

Turning now to FIG. 6, a block diagram of an example computing device 610 that may optionally be utilized to perform one or more aspects of techniques described herein is depicted. In some implementations, one or more of a client device (e.g., one or more of the plurality of client devices 130), generative content system component(s) or other cloud-based software application component(s) (e.g., component(s) of generative content system 140 and/or external system(s) 170), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein (e.g., as explained with respect to FIGS. 2, 3, and 4), as well as to implement various components depicted in FIGS. 1, 2, 5A, and 5B.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users (or make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In particular, the techniques described herein can be specifically designed to ensure that the privacy of personally identifiable or otherwise private information associated with a particular agent and/or user is maintained. As one example, agents can be instructed to ensure that agent queries containing personally identifiable or otherwise private information (which e.g., can be identified/flagged using a local GM accessible to the agent) are not transmitted for aggregation as part of a joint query. As an additional or alternative example, query issuing agents can be instructed to ensure that all individual agent queries are kept private (e.g., are not accessible to user(s) of a client device corresponding to the query issuing agent, are deleted from local storage at said client device, etc.). As an additional or alternative example, aggregation of the respective agent queries to form the joint query can include specifically prompting the entity that performs the aggregation (e.g., a local GM accessible to the query issuing agent) to generate a joint query which does not include any personally identifiable or otherwise private information. As an additional or alternative example, the agent queries described herein may be formed using a limited vocabulary of instructions, parameters, variables, etc. This can ensure that the form which the various agent queries take is not open ended, and is limited to a specific vocabulary which does not include personally identifiable or otherwise private information. Any or all of these techniques can be used to ensure that personally identifiable or otherwise private information does not form part of the joint query (because this joint query may be distributed to each agent of the plurality of agents) and cannot be used as a basis for generating responsive content (which also may be distributed to each agent of the plurality of agents).

In some implementations, a method implemented by one or more processors is provided, and includes: obtaining, from each agent of a plurality of agents, a respective agent query, where each respective agent query includes a respective natural language request for performance of a respective generative task; aggregating each respective agent query to form a joint query; causing the joint query to be processed using a generative model (GM) to generate responsive content; and broadcasting, to each agent of the plurality of agents, at least some of the responsive content generated using the GM, wherein the responsive content is responsive to the joint query.

These and other implementations of technology disclosed herein can optionally include one or more of the following features.

In some implementations, the method can further include: selecting, from the plurality of agents, a query issuing agent, where the query issuing agent can perform at least the causing of the joint query to be processed using the GM.

In some versions of those implementations, the query issuing agent can further perform one or more of: obtaining the respective agent queries; aggregating each respective agent query to form the joint query; and/or broadcasting at least some of the responsive content.

In some implementations, each of the respective agent queries can share one or more same or similar contextual factors.

In some versions of those implementations, the contextual factors can include one or more of: a time at which the respective agent query was obtained; a location from which the respective agent query was obtained; an embedding representation of the respective agent query; a type of the respective generative task; and/or input data for the respective generative task.

In some implementations, the GM can include a large language model (LLM).

In some versions of those implementations, the joint query can include a reference to one or more portions of text data, and causing the joint query to be processed using the GM can further include causing the one or more portions of text data to be processed using the GM.

In some implementations, the GM can include a multi-modal GM.

In some versions of those implementations, the joint query can include a reference to one or more portions of video data, one or more portions of audio data, and/or one or more images, and causing the joint query to be processed using the GM can further include causing the one or more portions of video data, the one or more portions of audio data, and/or the one or more images to be processed using the GM.

In some implementations, each agent of the plurality of agents can have access to a respective client GM of a plurality of client GMs.

In some versions of those implementations, each agent of the plurality of agents can correspond to a respective client device of a plurality of client devices, and, for each agent of the plurality of agents: the respective client GM can be hosted at the corresponding respective client device.

In some versions of those implementations, aggregating each respective agent query to form the joint query can include: processing, using the respective client GM accessible to the query issuing agent, first client GM input to generate corresponding first client GM output, the first client GM input including at least each respective agent query; and determining, based on the first client GM output, the joint query.

In some versions of those implementations, determining the joint query can further include: determining, based on the first client GM output, an interim query; broadcasting, by the query issuing agent, the interim query to one or more agents of the plurality of agents; receiving, at the query issuing agent, feedback from at least one of the one or more agents; processing, using the respective client GM accessible to the query issuing agent, second client GM input to generate corresponding second client GM output, the second client GM input including at least the interim query and the feedback; and determining, further based on the second client GM output, the joint query.

In some implementations, broadcasting the responsive content can further include: receiving, by the query issuing agent, the responsive content generated using the GM; and broadcasting, by the query issuing agent and to each agent of the plurality of agents, at least some of the responsive content.

In some versions of those implementations, for each agent of the plurality of agents, the method can further include: processing, using the respective client GM accessible to the agent, third client GM input to generate corresponding third client GM output, the third client GM input including at least some of the responsive content; and determining, based on the third client GM output, a portion of the responsive content which is responsive to the respective agent query for the agent.

In some versions of those implementations, the method can further include: causing the portion of the responsive content which is responsive to the respective agent query for the agent to be rendered at the respective client device.

In some implementations, the responsive content can include a digital signature.

In some versions of those implementations, for each agent of the plurality of agents, the method can further include: retrieving a public key corresponding to the GM; and verifying, using the public key and the digital signature, that the responsive content was determined using the GM.

In some implementations, the GM can be hosted remotely from the plurality of client devices.

In some implementations, the GM can be hosted at one or more of the plurality of client devices.

In some implementations, the method can further include: distributing, to each agent of the plurality of agents, the joint query; receiving, from one or more agents of the plurality of agents, feedback on the joint query; and updating the joint query to reflect the feedback.

In some versions of those implementations, updating the joint query can include processing the joint query and the feedback using the GM to generate output that updates the joint query.

In some implementations, the GM can be a foundation model.

In some implementations, an agent of a plurality of agents is provided, the agent including: at least one processor; and memory storing instructions that, when executed by the at least one processor, can cause the at least one processor to: determine an agent query, where the agent query can include a natural language request for performance of a generative task; transmit the agent query to a query issuing agent; receive, from the query issuing agent, a joint query, where the joint query can aggregate the agent query with one or more other agent queries each corresponding to a respective agent of the plurality of agents; receive, from the query issuing agent, responsive content generated using a generative model (GM), wherein the responsive content can be responsive to the joint query.

These and other implementations of technology disclosed herein can optionally include one or more of the following features.

In some implementations, the instructions can further cause the at least one processor to determine, based on a consensus of the plurality of agents, the query issuing agent from among the plurality of agents.

In some implementations, the GM can include a large language model (LLM).

In some versions of those implementations, the joint query can include a reference to one or more portions of text data.

In some implementations, the GM can include a multi-modal GM.

In some versions of those implementations, the joint query can include a reference to one or more portions of video data, one or more portions of audio data, and/or one or more images.

In some implementations, the agent can have access to a client GM.

In some versions of those implementations, the agent can correspond to a client device, and the client GM can be hosted at the client device.

In some versions of those implementations, the instructions can further cause the at least one processor to: receive, from the query issuing agent, an interim query; process, using the client GM, first client GM input to generate corresponding first client GM output, the first client GM input including at least the interim query; determine, based on the first client GM output, first feedback indicative of a degree of correspondence between the interim query and the agent query; and provide the first feedback to the query issuing agent, where the joint query can be received from the query issuing agent subsequent to providing the first feedback to the query issuing agent.

In some versions of those implementations, the instructions can further cause the at least one processor to: process, using the client GM, second client GM input to generate corresponding second client GM output, the second client GM input including at least the joint query; determine, based on the second client GM output, second feedback indicative of a degree of correspondence between the joint query and the agent query; and provide, based on the second feedback, a confirmation message to the query issuing agent indicative of approval of the joint query by the agent.

In some implementations, the instructions can further cause the at least one processor to: process, using the client GM, third client GM input to generate corresponding third client GM output, the third client GM input including at least the responsive content; and determine, based on the third client GM output, a portion of the responsive content which can be responsive to the agent query.

In some versions of those implementations, the instructions can further cause the at least one processor to: cause the portion of the responsive content which can be responsive to the agent query to be rendered at the client device.

In some versions of those implementations, the instructions can further cause the at least one processor to: cause the joint query to be rendered at the client device.

In some implementations, the responsive content can include a digital signature.

In some versions of those implementations, the instructions can further cause the at least one processor to: retrieve a public key corresponding to the GM; and verify, using the public key and the digital signature, that the responsive content was determined using the GM.

In some implementations, the GM can be a foundation model.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer-readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
obtaining, from each agent of a plurality of agents, a respective agent query, wherein each respective agent query comprises a respective natural language request for performance of a respective generative task;
aggregating each respective agent query to form a joint query;
causing the joint query to be processed using a generative model to generate responsive content; and
broadcasting, to each agent of the plurality of agents, at least some of the responsive content generated using the generative model, wherein the responsive content is responsive to the joint query.

2. The method of claim 1, further comprising selecting, from the plurality of agents, a query issuing agent, wherein the query issuing agent performs at least the causing of the joint query to be processed using the generative model.

3. The method of claim 2, wherein the query issuing agent further performs one or more of: obtaining the respective agent queries; aggregating each respective agent query to form the joint query; and/or broadcasting at least some of the responsive content.

4. The method of claim 1, wherein each of the respective agent queries share one or more same or similar contextual factors.

5. The method of claim 4, wherein the contextual factors include one or more of:
a time at which the respective agent query was obtained;
a location from which the respective agent query was obtained;
an embedding representation of the respective agent query;
a type of the respective generative task; and/or
input data for the respective generative task.

6. The method of claim 1, wherein the generative model comprises a large language model (LLM).

7. The method of claim 6, wherein the joint query comprises a reference to one or more portions of text data, and wherein causing the joint query to be processed using the generative model further comprises causing the one or more portions of text data to be processed using the generative model.

8. The method of claim 1, wherein the generative model comprises a multi-modal generative model.

9. The method of claim 8, wherein the joint query comprises a reference to one or more portions of video data, one or more portions of audio data, and/or one or more images, and wherein causing the joint query to be processed using the generative model further comprises causing the one or more portions of video data, the one or more portions of audio data, and/or the one or more images to be processed using the generative model.

10. The method of claim 1, wherein each agent of the plurality of agents has access to a respective client generative model of a plurality of client generative models.

11. The method of claim 10, wherein each agent of the plurality of agents corresponds to a respective client device of a plurality of client devices, and wherein, for each agent of the plurality of agents:
the respective client generative model is hosted at the corresponding respective client device.

12. The method of claim 11, wherein aggregating each respective agent query to form the joint query comprises:
processing, using the respective client generative model accessible to the query issuing agent, first client generative model input to generate corresponding first client generative model output, the first client generative model input comprising at least each respective agent query; and
determining, based on the first client generative model output, the joint query.

13. The method of claim 12, wherein determining the joint query further comprises:
determining, based on the first client generative model output, an interim query;
broadcasting, by the query issuing agent, the interim query to one or more agents of the plurality of agents;
receiving, at the query issuing agent, feedback from at least one of the one or more agents;
processing, using the respective client generative model accessible to the query issuing agent, second client generative model input to generate corresponding second client generative model output, the second client generative model input comprising at least the interim query and the feedback; and
determining, further based on the second client generative model output, the joint query.

14. The method of claim 1, wherein broadcasting the responsive content further comprises:
receiving, by the query issuing agent, the responsive content generated using the generative model; and
broadcasting, by the query issuing agent and to each agent of the plurality of agents, at least some of the responsive content.

15. The method of claim 14, further comprising, for each agent of the plurality of agents:
processing, using the respective client generative model accessible to the agent, third client generative model input to generate corresponding third client generative model output, the third client generative model input comprising at least some of the responsive content; and
determining, based on the third client generative model output, a portion of the responsive content which is responsive to the respective agent query for the agent.

16. The method of claim 15, further comprising:
causing the portion of the responsive content which is responsive to the respective agent query for the agent to be rendered at the respective client device.

17. An agent of a plurality of agents, the agent comprising:
at least one processor; and
memory storing instructions that, when executed by the at least one processor, cause the at least one processor to:
determine an agent query, wherein the agent query comprises a natural language request for performance of a generative task;
transmit the agent query to a query issuing agent;
receive, from the query issuing agent, a joint query, wherein the joint query aggregates the agent query with one or more other agent queries each corresponding to a respective agent of the plurality of agents;
receive, from the query issuing agent, responsive content generated using a generative model, wherein the responsive content is responsive to the joint query.

18. The agent of claim 17, wherein the instructions further cause the at least one processor to:
determine, based on a consensus of the plurality of agents, the query issuing agent from among the plurality of agents.

19. The agent of claim 17, wherein the generative model comprises a large language model (LLM).

20. The agent of claim 19, wherein the joint query comprises a reference to one or more portions of text data.
